(19) United States
(12) Patent Application Publication
(10) Pub. No.: US 2002/0081470 A1
(43) Pub. Date: Jun. 27, 2002

(54) Control method for heating processing system

(75) Inventors: Satoshi Hanai, Wako-Shi (JP); Takahiro Tachihara, Wako-Shi (JP); Yuji Asano, Wako-Shi (JP); Nobuyoshi Yoshida, Wako-Shi (JP)

Correspondence Address: LAHIVE & COCKFIELD, 28 STATE STREET, BOSTON, MA, 02109, US

(73) Assignee: HONDA GIKEN KOGYO KABUSHIKI KAISHA, Tokyo (JP)

(21) Appl. No.: 10/027,064

(22) Filed: Dec. 20, 2001

(30) Foreign Application Priority Data
Dec. 22, 2000 (JP) P2000-391701

(51) Int. Cl. H01M 8/04; H01M 8/06; G05D 23/00

(52) U.S. Cl. 429/20; 429/24; 422/105

(57) ABSTRACT

In a heat processing system for a fuel cell comprising a catalytic combustor 23 that has supplied and combusts an anode off gas and a cathode off gas discharged from a fuel cell stack 21, a vaporizer 24 that has introduced therein a combustion gas produced in the catalytic combustor 23, heats a raw fuel for a fuel cell by using the heat of the combustion gas to make it a fuel vapor, an off gas heater that heats the anode off gas and the cathode off gas by a combustion gas used in the vaporizer 24, a reformer 25 that reforms the fuel vapor produced by the vaporizer 24 and provides the fuel gas to the fuel cell stack 21, wherein the combustion gas temperature of the catalytic combustor 23 is set based on the required fuel vapor temperature, the flow volume of the cathode off gas is set and adjusted depending on this combustion gas temperature, and the set combustion gas temperature is compensated based on the required fuel vapor temperature and the actual fuel vapor temperature.

### BACKGROUND OF THE INVENTION

1. Field of the Invention

The present invention relates to a control method used, for example for a heating processing system that is advantageous for temperature control of a fuel vapor of a fuel cell system having a reformer.

2. Description of the Related Art

In a fuel cell system, a raw fuel of hydrocarbon or alcohol is reformed into a hydrogen rich fuel gas by a reformer, this fuel gas and an oxidizing agent gas (for example, air) are supplied to the anode electrode side and the cathode electrode side of the fuel cell as reacting gases, and power generation is carried out.

In this type of fuel cell system, conventionally the heat of the fuel exhaust gas discharged from the combustor or the like annexed to a reformer is recovered by heating a combustion fuel and combustion air that is supplied to a combustor using a heat exchange device disposed upstream from this combustor.

The control of the process temperature (the temperature of the reformed gas in the conventional example) of the heating object (the reformer in the conventional example) in this case is carried out by bypassing a part of the combusted exhaust gas supplied to the heat exchange device, adjusting the volume of flow through this bypass, adjusting the fuel exhaust gas temperature by providing a temperature regulator on the supply line of the fuel exhaust gas, and adjusting the amount of heat recovery (see for example, Japanese Unexamined Patent Application, First Publication, No. Hei 5-290865 and Japanese Unexamined Patent Application, First Publication, No. Hei 7-240233).

In addition, Japanese Unexamined Patent Application, First Publication, No. Hei 7-192742 discloses a technology in which process variables (reform reaction pipe wall temperature, combustor temperature) which relate strictly to the process temperature of the control object and respond well to control operation are added to the control variables, and thereby the stabilization of the process temperature (reform gas outlet temperature, reform catalyst layer temperature) of the heating object can be implemented.

However, in the conventional control method, because there is no device that detects the change in the process state through time that occurs due to the influence of the heat capacity of the heat recovery device, the combustor, which are heating objects, or the heat transmission speed, in the case that the amount of heat recovered in the combusted fuel or the fuel air fluctuates due to a change in the load or the like, or in the case that the temperature of the combustion fuel or the combustion air supplied to the combustor fluctuates, there is the problem that it is not possible to adjust with high responsiveness the amount of heat supplied to the heating object or the combustion gas temperature depending on the process state, and as a result, control having a large overshoot or undershoot occurs, and the process temperature of the heating object is not stable.

In addition, in the case that a heat detector such as a thermistor or a thermocouple is used as a device that detects the combustion gas temperature of the combustor, there is the problem that even when the amount of the combustion air changes due to the heat capacity of the combustor and the radiant heat of the combustion, the combustion gas temperature cannot be detected with high responsiveness.

### SUMMARY OF THE INVENTION

Thus, an object of the present invention is to provide a stable control method for a heat processing system that can control the process temperature of the heating object with high responsiveness.

In order to solve the problems described above, in a first aspect of the present invention, a control system for a heat processing system having a combustor (for example, the catalytic combustor 23 in the third and fourth embodiments described below) that has supplied and combusts fuel and air, a heating device (for example, the vaporizer 24 in the third and fourth embodiments described below) that heats the heating object by introducing the combustion gas produced by the combustor and using the heat of the combustion gas, and a heat exchange device (for example, the off gas heater 22 in the third and fourth embodiments described below) that introduces the combustion gas used by the heating device and transfers the heat to the fuel and the air from the combustion gas, is characterized in that the combustion gas temperature of the combustor is set based on the required value with respect to the temperature of the heating object obtained by heat processing by the heating device; the flow volume of the air is set and adjusted depending on the set combustion gas temperature; and the set combustion gas temperature is compensated based on the comparative value of the required value for the temperature of the heating object and the actual temperature of the heating object after the heating process and the temperature of the heating object after the heat processing is controlled so as to obtain the required value.

By constructing this type of structure having a simple structure, the temperature of the heating object after heating processing can be stably controlled with a high responsiveness.

In a second aspect of the present invention, a control system for a heat control system having a combustor (for example, the combustor 1 in the first embodiment and the catalytic combustor 23 in the second embodiment, both described below) that has supplied and combusts fuel and air, a heating device (for example, the first heater 2 in the first embodiment and the vaporizer 24 in the second embodiment, both described below) that heats the heating object by introducing the combustion gas produced by the combustor and using the heat of the combustion gas, and a heat exchange device (for example, the second heater 3 in the first embodiment and the off gas heater 22 in the second embodiment, both described below) that introduces the combustion gas used by the heating device and transfers the heat to the fuel and the air from the combustion gas, wherein: the amount of heat supplied to the heating device and the combustion gas temperature of the combustor are set based on the required value of the amount and the temperature of the heating object obtained by the heat processing by the heating device; the flow volume of the fuel and the flow volume of the air are set and adjusted depending on the set amount of supplied heat and the set combustion gas temperature; and at least one of either the set amount of heat supplied or the set combustion gas temperature is compensated based on the comparative value of the required value relating to the temperature of the heating object and the actual temperature of the heating object after the heat processing, and the temperature of the heating object after the heating processing is controlled so as to attain the required value.

By constructing this type of structure, the temperature of the heating object after heating can be stably controlled with high responsiveness while having a simple structure. In the case that both the set amount of heat supplied and the set fuel gas temperature are compensated based on the comparative value of the required value relating to the temperature of the heating object and the actual temperature of the heating object after heat processing, the temperature of the heating object after heat processing can be controlled more stably.

Moreover, in the invention according to the first aspect and the invention according to the second aspect, the comparative value of the required value related to the temperature and the actual temperature can also be the temperature difference between the required value and the actual temperature, or the temperature ratio.

In a third aspect of the present invention, a control method for a heat processing system according to the first aspect or the second aspect is characterized in the oxygen concentration corresponding to the set combustion gas temperature is found using a map (for example, the map II in the first embodiment and the map IV in the second and third embodiments described below) that shows the corresponding relationships between the combustion gas temperature and the oxygen concentration in the combustion gas, and the volume of the air is adjusted so that the actual oxygen convention of the combustion gas of the combustor approaches the required oxygen concentration.

By constructing this type of structure, the combustion gas temperature of the combustor and the amount of heat supplied to the heating device can be controlled with high responsiveness depending on the process state.

In a fourth aspect of the present invention, a control method for a heat processing system according to any of the first aspect through the third aspect is characterized in that heating object prior to the heat processing by the heating device is the raw fuel of the fuel cell (for example, the fuel cell stack 21 in the second through fourth embodiments descried below), the heating device is a vaporizer (for example, the vaporizer 24 in the second and fourth embodiments described below) that generates the fuel vapor by vaporizing the raw fuel, the heating object obtained by heat processing by the heating device is a fuel vapor produced by the vaporizing device, the fuel is the anode off gas discharged after the fuel gas generated by reforming by a reformer (for example, the reformer 25 in the second through fourth embodiments described below) that has been supplied to the anode electrode (for example, the anode electrode 21a in the second through fourth embodiments described below) of the fuel cell (for example, the fuel stack 21 in the second through fourth embodiments described below) and the air is the cathode off gas discharged after the air is supplied to the cathode electrode (for example, the cathode electrode 21b in the second through fourth embodiments described below) of the fuel cell.

By constructing this type of structure, the fuel vapor supplied to the reformer from the vaporizer can be stably controlled so as to obtain the required fuel vapor temperature in the reformer.

### BRIEF DESCRIPTION OF THE DRAWINGS

FIG. 1 is a system structure drawing of the first embodiment of the control method of the heat control system according to the present invention.

FIG. 2 is a map I used in the first embodiment, and is a map that shows the relationship between the process heat and the combustion gas temperature with respect to the amount of supplied heat.

FIG. 3 is a map II used in the first embodiment, and is a map that shows the relationship between the temperature of the heat generated by combustion and the oxygen concentration in the combustion gas.

FIG. 4 is a system structure drawing of the second embodiment of the control method of the heat control system according to the present invention.

FIG. 5 is a block diagram showing the control procedure in the second embodiment.

FIG. 6 is a map III used in the second embodiment, and is a map showing the relationship between the process heat and the combustion gas temperature with respect to the amount of supplied heat.

FIG. 7 is a map IV used in the second embodiment, and is a map that shows the relationship between the temperature generated by combustion and the oxygen concentration in the combustion gas.

FIG. 8 is a system structure drawing of the third embodiment of the control method of the heat control system according to the present invention.

FIG. 9 is a system structure drawing of the fourth embodiment of the control method of the heat control system according to the present invention.

FIG. 10 is a map V used in the fourth embodiment, and is a map showing the relationship between the temperature generated by combustion and the amount of the cathode off gas flow.

### DETAILED DESCRIPTION OF THE INVENTION

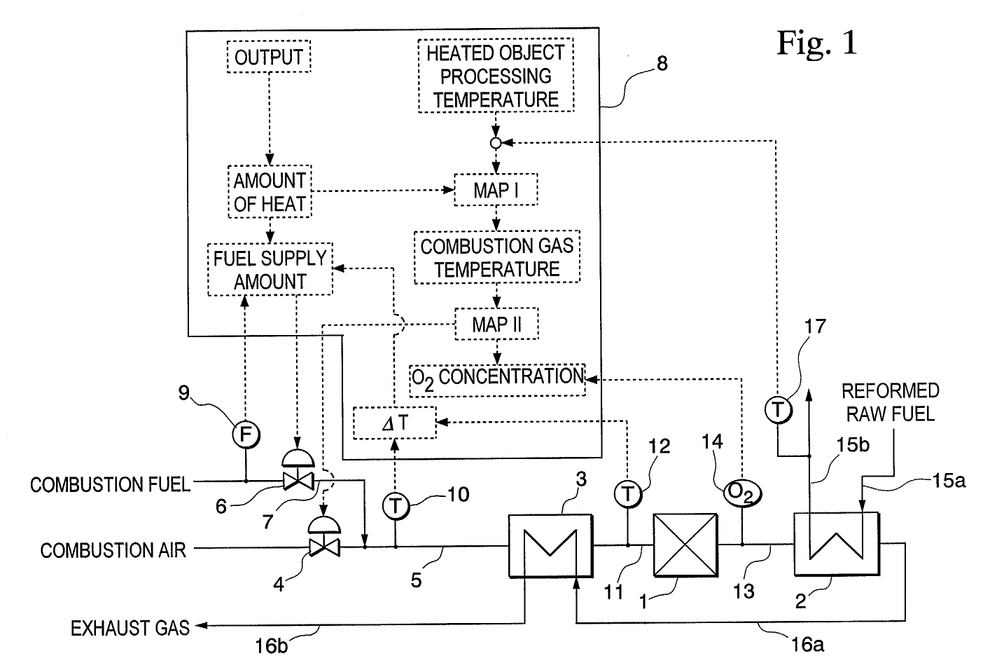

Hereinafter, embodiments of the control method for a heat processing system according to the present invention will be explained with reference to FIG. 1 to FIG. 10.

First Embodiment

First, the first embodiment of the control method for a heat processing system according to the present invention will be explained while referring to the drawings in FIG. 1 to FIG. 3.

FIG. 1 is a drawing showing the schematic structure of the heat processing system, and in FIG. 1, the control process sequence is also shown in order to make the processing the in the control unit easy to understand. This heat processing system comprises a combustor 1, a first heater 2 that heats the heating object using the heat of the combustion gas generated by the combustor 1, and a second heater 3 that heats the combustion fuel and the combustion air supplied to the combustor 1 using the heat of the combustion gas discharged from the first heater 2 after heating the heating object.

In the second heater 3, combustion air can be supplied via a fluid supply pipe 5 having an air flow volume control valve 4. In addition, in a fluid supply pipe 5 that is further downstream than the air flow volume control valve 4, a fuel supply pipe 7 having a fuel flow volume control valve 6 is connected, and the combustion fuel can be supplied to the second heater 3 via the fuel supply pipe 7 and the fluid supply pipe 5. A fuel flow volume sensor 9 that outputs an electrical signal that depends on the flow volume of the fuel that flows through the fuel supply pipe 7 to a control unit 8 is provided on the fuel supply pipe 7. In addition, an inlet temperature sensor 10 that outputs an electrical signal that depends on the degree of the temperature of the mixed gas (below, referred to as the “combustion mixed gas”) comprising the combustion fuel and the combustion air flowing in the second heater 3 to the control unit 8 is provided on the fluid supply pipe 5 disposed further downstream than the junction with the fuel supply pipe 7.

After the combustion mixed gas is heated in the second heater 3, it is supplied to the combustor 1 via the mixed gas supply pipe 11. The outlet temperature sensor 12 that outputs an electrical signal that depends on the degree of the temperature of the combustion mixed gas flowing out from the second heater 3 to the control unit 8 is provided on the mixed gas supply pipe 11.

The combustion mixed gas is combusted in the combustor 1, and the combustion gas having a high temperature due to the combustion is supplied to the first heater 2 via the combustion gas supply pipe 13. An oxygen concentration sensor 14 that outputs an electrical signal that depends on the amount of the oxygen concentration in the combustion gas flowing out from the combustor 1 to the control unit 8 is provided on the combustion gas supply pipe 13.

The heating object is supplied via the hated object supply pipe 15a to the first heater 2, in the first heater 2 heat exchange is carried out between the combustion gas supplied from the combustor 1 and the heating object, and the heating object is supplied to the process (not illustrated) via the heating object discharge pipe 15b. In contrast, the combustion gas whose temperature has been lowered due to heating the heating object is introduced as a heat source into the second heater 3 via the exhaust gas pipe 16a. A process temperature sensor 17 that outputs an electric signal that depends on the degree of the temperature (below, referred to as the “process temperature”) of the heating object after heating to the control unit 8 is provided on the heating object discharge pipe 15b.

The combustion gas supplied to the second heater 3 via the exhaust gas pipe 16a heats the combustion mixed gas supplied to the second heater 32 via the fluid supply pipe 5, and thereby the cooled combustion gas is emitted to the atmosphere via the exhaust gas pipe 16b.

Next, in this heat processing system, the method of controlling the process temperature of the heating object so as to obtain the process temperature that the process requires (below, referred to as the “required process temperature”).

First, the control unit 8 sets the output required by the process (this corresponds to the supply volume of the heating object to be supplied to the process) depending on the operational state of the process (below, referred to as the “required output”), and at the same time sets the required process temperature of the heating object required by the process.

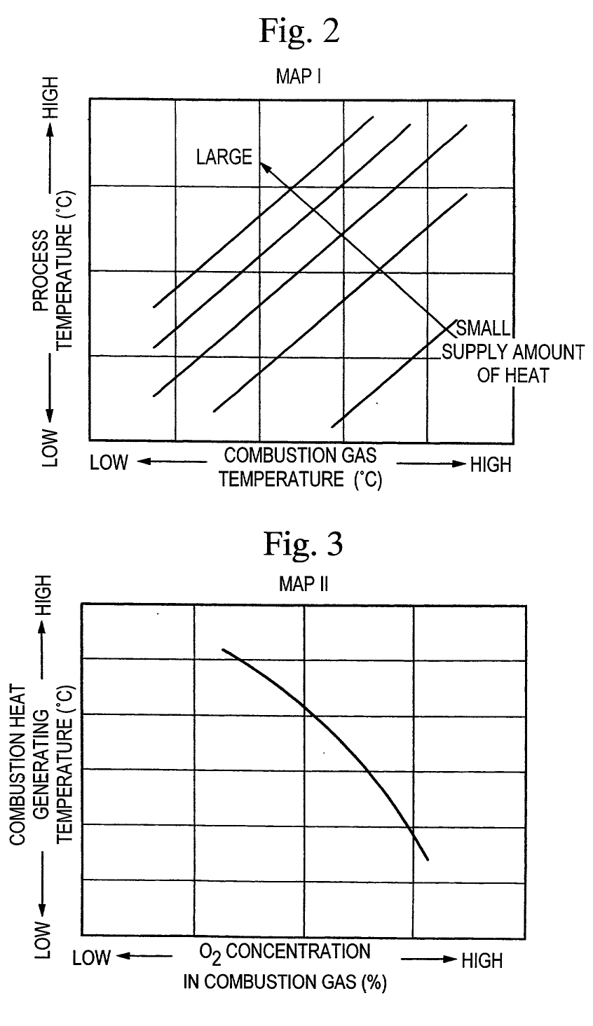

Next, the amount of heat supplied (below, referred to as the set amount of heat supplied) to be supplied to the heating object, or in other words, the amount of heat supplied to the first heater 2, is calculated, and based on the set amount of heat supplied and the required process temperature, the combustion gas temperature is set (below, referred to as the set combustion gas temperature) by referring to the map I in FIG. 2, which shows the relationship between the process temperature, the combustion gas temperature, and the set amount of heat supplied. Moreover, map I has been obtained experimentally, and is stored in ROM (read only memory; not illustrated).

Next, the temperature difference ΔT is found from the output values of the inlet temperature sensor 10 and the and the outlet temperature sensor 12 provided upstream and downstream from the second heater 12, the amount of heat recovered by the second heater is calculated, the supply amount of the combustion fuel necessary for obtaining this amount of heat is found by subtracting the amount of heat recovered by the second heater 3 from the set supplied heat amount, and the fuel flow volume control valve 6 is controlled while monitoring the output signal of the fuel flow volume sensor 9 so as to obtain this necessary fuel supply amount.

Next, the oxygen concentration in the combustion gas (below, referred to the “combustion gas oxygen concentration”) corresponding the set combustion gas temperature is found by referring to the Map II in FIG. 3, which shows the relationship between the temperature of the heat generated by combustion and the oxygen concentration in the combustion gas, and the feedback control of the air flow volume control valve 4 is carried out based on the output signal of the oxygen concentration sensor 14 so as to obtain this combustion gas oxygen concentration. Moreover, map II has been obtained experimentally, and is stored in ROM (read only memory; not illustrated).

Moreover, map II is for estimating the combustion gas temperature from the combustion gas oxygen concentration, or estimating the inverse, and the basis of these estimates is as follows. The amount of heat generated in the case that the combustion fuel is completely combusted is determined by the amount of the fuel. In addition, the minimum amount of air necessary to completely combust the combustion fuel is determined depending on the amount of the fuel. Therefore, the temperature of the heat generated by combustion (that is, the combustion gas temperature) in the case that the fuel is completely combusted by the minimum air volume should be constant if there is no heat loss or the like, the temperature of the heat generated by combustion decreases to the extent that the air volume is greater than the minimum air volume, and the oxygen concentration in the combustion gas raises. Map II is found from experimental data that is obtained by carrying out experiments in this heat processing system based on this conception.

Next, the temperature difference between the required process temperature of the heating object and the temperature of the heating object found from the output value of the process temperature sensor 17 is fed back, and the set value of the combustion gas temperature supplied to the heating object is compensated.

In this manner, in the control method of the heat process system of the first embodiment, because the temperature of the heat generated by combustion in the combustor 1 is estimated from the oxygen concentration in the combustion gas discharged from the combustor 1, in the case that the amount of the heat recovered in the combustion fuel and combustion air in the second heater 3 and the temperature of the combustion mixed gas supplied to the combustor 1 fluctuates due to the load fluctuation time of the heating object, no response delay is produced in the detection of the temperature of the heat generated by combustion (the combustion gas temperature) caused by the heat capacity of the combustor and the combustion radiation heat, and the temperature of the heat generated by combustion (combustion gas temperature) can be detected with good response.

In addition, in controlling each of the supply volumes of the combustion fuel and the combustion air to be supplied to the combustor 1, the amount of heat recovered in the combustion mixed gas from the combustion gas in the second heater 3 is taken into consideration, and thus in the case that the amount of recovered heat of the combustion fuel and the combustion air in the second heater 3 and the temperature of the combustion mixed gas supplied to combustor 1 fluctuate due to the load fluctuation time of the heating object, the amount of heat supplied to the heating object and a combustion gas temperature can be maintained at a constant, and the process temperature of the heated process can be stabilized.

Furthermore, the inlet temperature sensor 10, the outlet temperature sensor 12, the process temperature sensor 17, and the oxygen concentration sensor 14 all closely follow fluctuations in the state, and can detect changes in the process state through time. Thus, the amount of heat supplied to the heating object and the combustion gas temperature can be controlled with high responsiveness.

Moreover, in the first embodiment, the difference between the required process temperature of the heating object and the temperature of the heating object found from the output value of the process temperature sensor 17 is fed back, and the set value of the combustion gas temperature supplied to the heating object is compensated. However, instead compensating the set value of the combustion gas temperature, the set value of the combustion gas temperature can be compensated and at the same time, the set value of the amount of heat supplied to the heating object can be compensated.

Second Embodiment

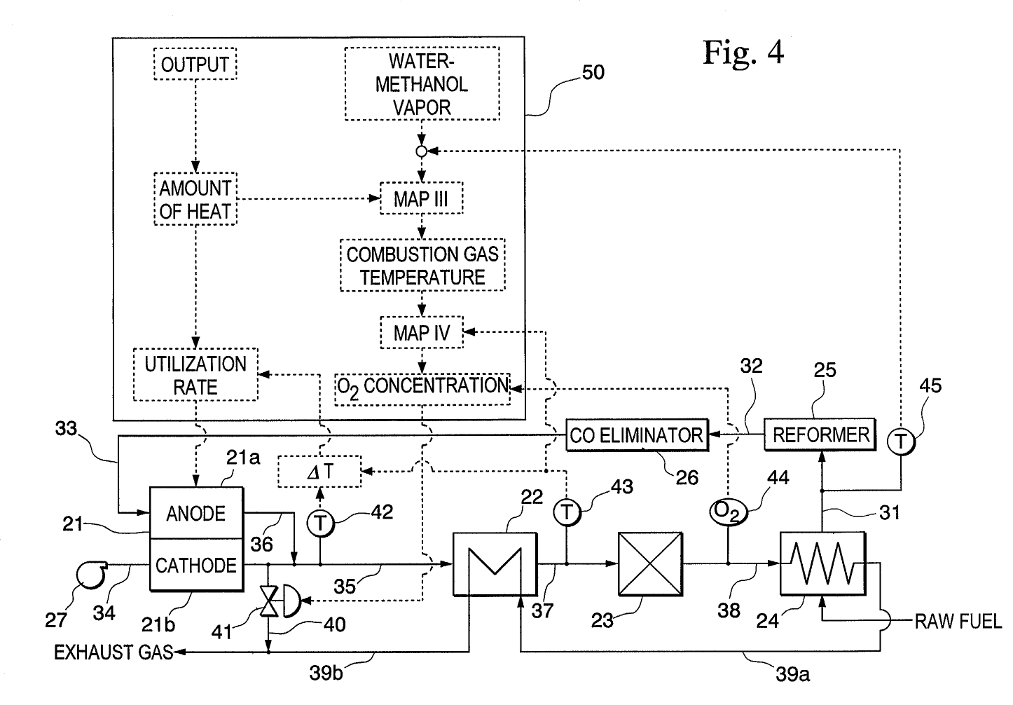

Next, the second embodiment of the control system of a heat processing system according to the present invention will be explained with reference to FIG. 4 to FIG. 7. The second embodiment of the heat processing system is a form applied to a fuel cell system mounted on a fuel cell vehicle.

FIG. 4 is a drawing showing the schematic structure of the fuel cell system, and in FIG. 4 the control process sequence is also shown in order to make the processing the in the control unit easy to understand.

The fuel cell system comprises as essential elements a solid polymer-type fuel cell stack (fuel cell) 21, an off gas heater 22, a catalytic combustor 23, an vaporizer 24, a reformer 25, a CO eliminating device 26, and a supercharger 27.

The fuel cell stack 21 generates power by an electrochemical reaction between the hydrogen in the fuel gas supplied to the anode electrode 21a side and the oxygen in the air that serves as the oxidizing agent gas supplied to the cathode electrode 21b side.

The combustion gas supplied to the anode electrode 21a side of the fuel cell stack 21 that is used is one that is a raw fuel that has been vaporized into a fuel vapor by the vaporizer 24, and then reformed to an oxygen high fuel gas by a reformer 25. Finally, the CO is eliminated from this fuel gas by the CO eliminating device 26.

Specifically, a raw fuel for reforming that comprises, for example, methanol and water mixed in predetermined ratio, and the air for reforming are supplied to the vaporizer 24, and in the vaporizer 24, the raw fuel for reforming and the air for reforming are heated by a non-contact heat exchange with the high-temperature combustion gas supplied from the catalytic combustor 23, the fuel for reform is becomes a vapor fuel due to vaporization, and has its temperature raised to 200 to 300° C. after being mixed with the heated air. In this state, it is supplied to the reformer from the vaporizer 24 via the fuel supply pipe 31.

The reformer is an autothermal-type reformer, and reacts the fuel vapor and air for reforming to reform them into a hydrogen rich fuel gas. The reformed fuel gas is supplied to the CO elimination device 26 via the fuel gas supply pipe 32, the CO in the fuel gas in the CO eliminating device 26 is eliminated by oxidation, and the fuel gas having the CO eliminated is supplied to the anode electrode 21a side of the fuel cell stack 21 via the fuel gas supply pipe 33.

In contrast, the air supplied to the cathode electrode 21b side of the fuel cell stack 21 is supplied from the supercharger after being humidified by a humidifier (not illustrated) via an air supply pipe 34.

After the air supplied to the cathode electrode 21b side of the fuel cell stack 21 has served in power generation, is it supplied to the off gas heater 22 as cathode off gas via the off gas pipe 25. In addition, after the fuel gas supplied to the anode electrode 21a side has served in power generation, it is supplied to the off gas heater 22 as anode off gas via the off gas pipe 36 and the off gas pipe 35.

After the anode off gas and the cathode off gas (below, referred to as off gas in the case that there is no particular need to distinguish them) are heated in the off gas heater 22, they are introduced into the catalytic combustor 23 via the off gas pipe 37.

The catalytic combustor 23 reacts (combusts) the hydrogen remaining in the anode off gas and the oxygen remaining the cathode off gas, and the combustion gas whose temperature has become high due to this reaction serves as the heat source that heats the raw fuel for reform and the air for reform, and is supplied to the vaporizer 24 via the off gas pipe 38.

In the vaporizer 24, the combustion gas whose temperature has been lowered due to heat exchange with the raw fuel for reforming and the air for reforming serves as the heat source that heats the off gas discharged from the fuel cell stack 21, is supplied to the vaporizer 24 via the off gas pipe 39a, and subsequently is emitted to the atmosphere via the exhaust pipe 39b as exhaust gas.

In addition, the off gas pipe 35 and the exhaust pipe 39b that are positioned farther upstream than the junction with the off gas pipe 36 is connected by the cathode off gas bypass pipe 40, and a cathode off gas flow volume control valve 41 is provided on this cathode off gas bypass pipe 40. The cathode off gas flow volume control valve 41 is a control valve for controlling the flow volume of the cathode off gas supplied to the off gas heater 22, and the cathode off gas volume supplied to the off gas heater 22 by making the aperture of the cathode off gas flow volume control valve 41 large can be decreased, and the volume of cathode off gas supplied to the off gas heater 22 can be increased by making the aperture of the cathode off gas flow volume control calve 41 small.

An inlet temperature sensor 42 that outputs an electrical signal that depends on the degree of the temperature of the off gas flowing into the off gas heater 22 to the control unit 50 is provided on the off gas pipe 35 positioned farther downstream than the junction with the off gas pipe 36.

An outlet temperature sensor 43 that outputs an electrical signal that depends on the degree of the temperature of the off gas flowing out from the off gas heater 22 to the control unit 50 is provided on the off gas pipe 37.

A oxygen concentration sensor 44 that outputs an electrical signal that depends on the amount of the oxygen concentration in the combustion gas that flows out from the catalytic combustor 23 to the control unit 50 is provided on the off gas pipe 38.

In addition, a fuel vapor temperature sensor 45 that outputs an electrical signal that depends on the degree of the temperature of the fuel vapor (that is, the temperature of the water-methanol vapor) flowing into the reformer 25 to the control unit 50 is provided on the fuel supply pipe 31.

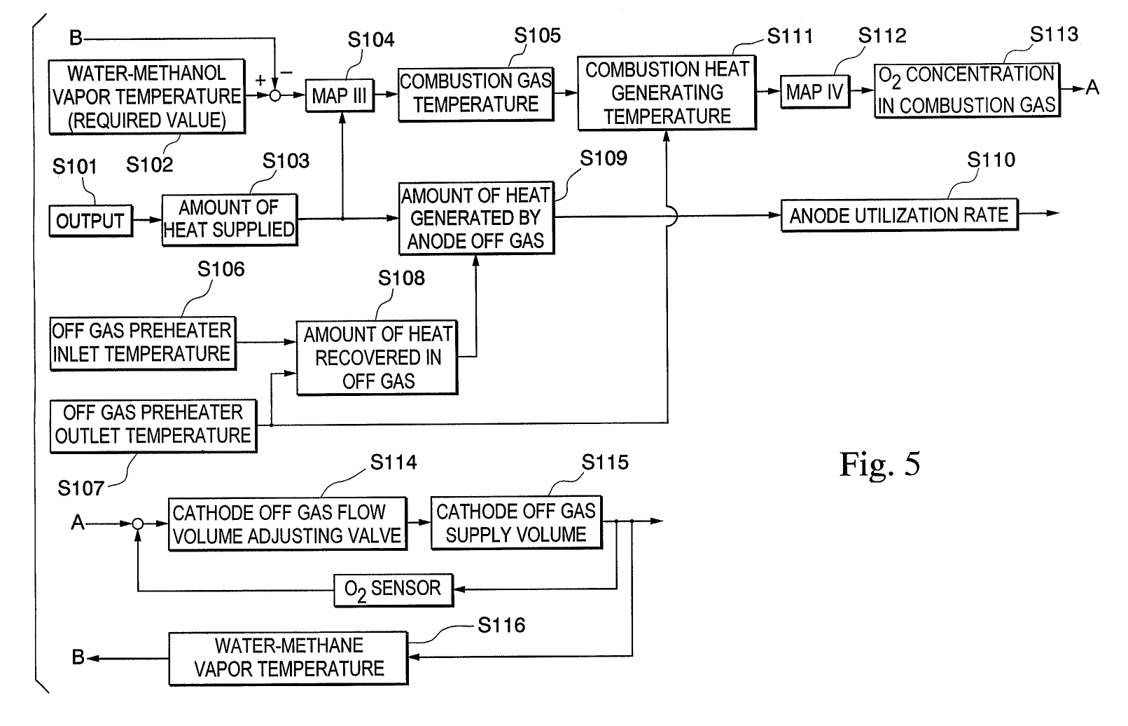

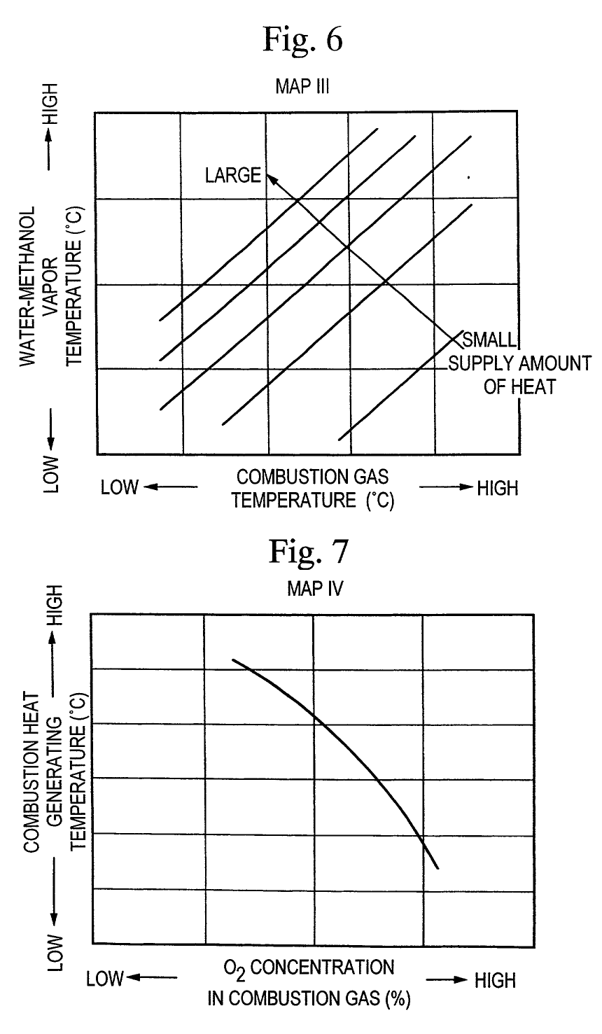

Next, in this fuel cell system, the method of controlling the temperature of the fuel vapor supplied to the reformer from the vaporizer 24 to the fuel vapor temperature required by the reformer 25 (below, referred to as the “required fuel vapor temperature”) will be explained while referring to the block drawings in FIG. 5 and FIG. 6.

First, the control unit 50 sets (step S 101) the output required by the fuel cell stack 21 depending on the operational state of the fuel cell vehicle (below, referred to as the “required output”), and at the same time, sets (step S 102) the fuel vapor temperature required by the reformer 25 (below, referred to as the required fuel vapor temperature). Moreover, the required output corresponds to the amount of fuel vapor required by the reformer 25, and therefore, corresponds to the amount of raw fuel required by the vaporizer 24.

Next, the amount of heat to be supplied to the vaporizer 24 (below, referred to as the set amount of heat supplied) is calculated (step S 103), and based on this set amount of heat supplied and the required fuel vapor temperature, the combustion gas temperature is set (step S 105) by referring to a map III (step S 104) in FIG. 6, which shows the relationship between the fuel vapor temperature (the temperature of the water-methanol vapor temperature) that corresponds to the amount of heat supplied to the vaporizer 24 and the combustion gas temperature. Below, this combustion gas temperature is referred to as the “set combustion gas temperature”. Moreover, the map III is found in advance experimentally and then stored in a ROM (read only memory; not illustrated).

Next, the output values of the inlet temperature sensor 42 and the outlet temperature sensor 43 provided respectively upstream and downstream from the off gas heater 22 are read (step S 106 and step S 107), and the amount of off gas recovered heat is found from the temperature difference ΔT therebetween (step S 108).

In addition, the amount of the necessary anode off gas heat generation is calculated (step S 109) by subtracting the amount of heat recovered by the off gas heater 22 from the amount of the set supplied heat, the anode utilization rate necessary to obtain this amount of anode off gas heat generation is set (step S 110), and the anode utilization rate change device (not illustrated) is adjusted so as to obtain this anode utilization rate. Here, the anode utilization rate device the ratio of the fuel amount supplied to the anode electrode 21a side of the fuel cell stack 21 and the amount of fuel actually used for power generation, and the smaller the anode utilization rate, the larger the amount of fuel in the anode off gas, and the larger the anode utilization rate, the smaller the amount of fuel in the anode off gas. This device that by controlling the anode utilization rate, the amount of fuel supplied to the catalyst combustor 23 can be controlled.

Next, the combustion heat generation temperature is calculated by subtracting the off gas temperature after heating detected by the outlet temperature sensor from the set fuel gas temperature (step S 111), and the combustion gas oxygen concentration corresponding to this combustion heat generation temperature is found (step S 113) by referring to the map IV in FIG. 7, which shows the relationship between the combustion heat generation temperature and the oxygen concentration in the combustion gas (step S 112).

In addition, feed back control is carried out on the cathode off gas flow volume control valve 41 based on the output value of the oxygen concentration sensor 44 so as to obtain this combustion gas oxygen concentration (step S 114), and the cathode off gas supply amount is controlled (step S 115). Moreover, the map IV corresponds to the map II in the first embodiment, and in this fuel cell system is found in advance experimentally and stored on a ROM (read only memory; not illustrated).

In addition, the temperature difference between the fuel vapor temperature detected by the fuel vapor temperature sensor 45 (step S 116) and the required fuel vaporization temperature are fed back so that the fuel vapor temperature obtains the required fuel vapor temperature, and the set value of the temperature of the combustion gas supplied to the vaporizer 24 is compensated.

In this manner, in the control method for fuel vapor temperature in the fuel cell system of the second embodiment, because the combustion heat generation temperature in the catalytic combustor 23 is estimated from the oxygen concentration in the combustion gas discharged from the catalytic combustor 23, in case in which the amount heat recovered from the off gas in the off gas heater 22 and the temperature of the off gas serving as the fuel gas supplied to the catalytic combustor 23 fluctuate through time due to the variation of the load on the fuel cell vehicle and the like, there is no response delay occurs in the detection of the fuel heat generation temperature (combustion gas temperature) caused by the heat capacity of the catalytic combustor 23 or combustion radiated heat, and the combustion heat production temperature (combustion gas temperature) can be detected with good responsiveness.

In addition, because the amount of heat recovered by the off gas from the combustion gas in the off gas heater 22 is taken into consideration in controlling the anode utilization rate, even in cases in which the amount heat recovered from the off gas in the off gas heater 22 and the temperature of the off gas supplied to the catalytic combustor 23 fluctuates due to the of the load fluctuation time of the fuel electric vehicle and the like, the amount of heat supplied to the vaporizer 24 and the combustion gas temperature can be held constant, and the combustion vapor temperature supplied to the reformer 25 from the vaporizer 24 can be stabilized.

Furthermore, the inlet temperature sensor 42, the outlet temperature sensor 43, the fuel vapor temperature sensor 45, and the oxygen concentration sensor 44 all closely follow fluctuations in the state, and can detect changes in the process state through time. Thus, the amount of heat supplied to the vaporizer 24 and the combustion gas temperature can be controlled with high responsiveness.

Therefore, the fuel vapor at the required temperature and in the required amount can be stably supplied to the reformer 25, and as a result, the fuel gas for the fuel cell stack 21 that is required depending on the operational state of the fuel and electric vehicle can be supplied in the necessary amounts at a stable gas composition.

Moreover, in the second embodiment, the temperature difference between the required fuel vapor temperature and the fuel vapor temperature found from the output value of the fuel vapor temperature sensor 45 is fed back, and the set value of the combustion gas temperature supplied to the vaporizer 24 is compensated, but instead of compensating the set value of the combustion gas temperature, the set value of the of the combustion gas temperature can be compensated, and at the same time, the set value of the amount of heat supplied to the vaporizer 24 can be compensated.

Third Embodiment

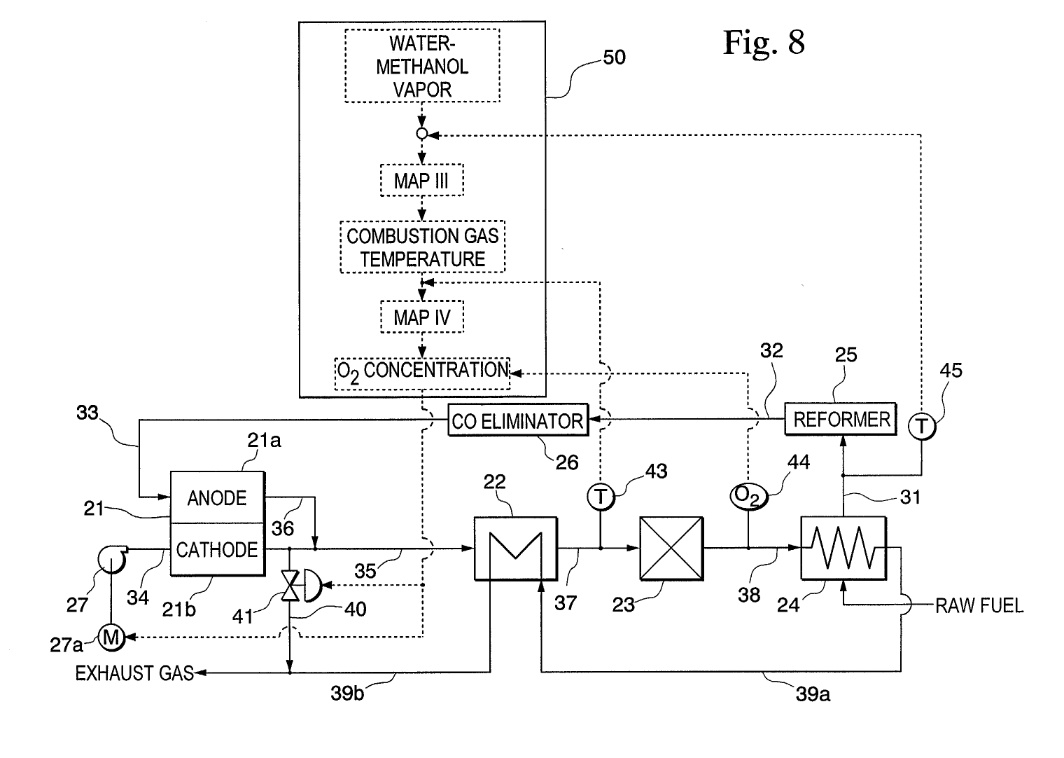

Next, the third embodiment of the control method for a heat processing system according to the present invention will be explained with reference to FIG. 8. Like the second embodiment, the heat processing system according to the third embodiment can be used in a fuel cell system mounted in a fuel cell vehicle.

FIG. 8 is a drawing showing the schematic structure of the fuel cell system according to the third embodiment, and in FIG. 8 the control process sequence is also shown in order to make the processing the in the control unit easy to understand.

The point of difference between the fuel cell system according to the third embodiment and that according to the second embodiment is as follows. First, with regards to the system structure, there is no the inlet temperature sensor 42, that is a temperature sensor for detecting the temperature of the off gas flowing into the off gas heater 22, provided on the off gas pipe 35. The other structures are identical to those of the second embodiment, and thus identical parts are denoted by identical reference numerals and their explanation is omitted.

The fuel cell system according to the third embodiment is used in the case that the output required by the fuel cell stack 21 is substantially constant even when the operational state changes due to, for example, an energy source separate from the battery being provided in the fuel cell vehicle, and in the case that the influence that this output fluctuation on the controllability is held within a tolerated range even if the output required by the fuel cell stack 21 changed depending on the operational state of the fuel cell vehicle.

Therefore, in the system according to the third embodiment, the explanation will be made assuming that the output of the fuel cell stack 21 is constant.

If the output of the fuel stack 21 is constant, the amount of heat supplied to the vaporizer 24 will be constant, and if the amount of heat supplied to the vaporizer 24 is constant, the parameter contributing to temperature of the fuel vapor flowing out from the vaporizer 24 is only the temperature of the fuel gas supplied from the vaporizer 24. Thus, in the third embodiment, by controlling only the temperature of the fuel gas, the temperature of the fuel vapor can be controlled so as to obtain the required vapor temperature. The reason that there is no inlet temperature sensor 10 is that adjusting the amount of supplied heat is not necessary.

Next, the processing sequence of the fuel vapor temperature for the fuel cell system according to the third embodiment will be explained.

First, the control unit 50 sets the fuel vapor temperature (that is, the required fuel vapor temperature) required by the reformer 25 based on the operational state of the fuel cell vehicle.

Next, based on this required fuel vapor temperature, the fuel gas temperature (that is, the set fuel gas temperature) is set by referring to map III in FIG. 6, which shows the relationship between the fuel vapor temperature (the water-methanol vapor temperature) and the combustion gas temperature with respect to the amount of heat supplied to the vaporizer 24.

Next, the combustion heat generation temperature is calculated by subtracting the off gas temperature that is detected by the outlet temperature sensor 43 after heating from this set combustion gas temperature, and the combustion gas oxygen concentration corresponding to this combustion heat generation temperature is found by referring to the map IV in FIG. 7, which shows the relationship between the combustion heat generation temperature and the oxygen concentration in the combustion gas.

In addition, the cathode off gas flow volume control valve 41 is controlled by feed back based on the output value of the oxygen concentration sensor 44 so as to obtain the required combustion gas oxygen concentration, and the cathode off gas supply volume is controlled. Moreover, instead of controlling the cathode off gas flow volume control valve 41, the amount of blown air can be adjusted by controlling the revolutions of the drive motor 27a of the supercharger 27, and thereby the cathode off gas supply volume can be controlled.

In addition, the temperature difference between the fuel vapor temperature detected by the fuel vapor temperature sensor 45 and the required fuel vapor temperature is fed back so that the fuel vapor temperature obtains the required fuel vapor temperature, and the set value of the temperature of the combustion gas supplied to the vaporizer 24 is compensated.

In this manner, in the control system for the fuel vapor temperature in the fuel cell system according to the third embodiment, the combustion heat generation temperature in the catalytic combustor 23 is estimated based on the oxygen concentration in the combustion gas discharged from the catalytic combustor 23, and thus response delays in the detection of the combustion heat generation temperate (the combustion gas temperature) caused by the heat capacity of the catalytic combustor 23 and the combustion radiated heat do not occur, and the combustion heat generation temperature (combustion gas temperature) can be detected with a high responsiveness.

In addition, the outlet temperature sensor 43, the fuel vapor temperature sensor 45, and the oxygen concentration sensor 44 all closely follow the change in state and can detect the change in the process state through time, and thus the temperature of the combustion gas supplied to the vaporizer 24 can be controlled with high responsiveness. Therefore, the fuel vapor can be stably supplied to the reformer 25.

Furthermore, in the control method of the fuel vapor temperature in the fuel cell system according to the third embodiment, because the inlet temperature sensor is not necessary, the system structure can be simplified, and the costs can be reduced.

Fourth Embodiment

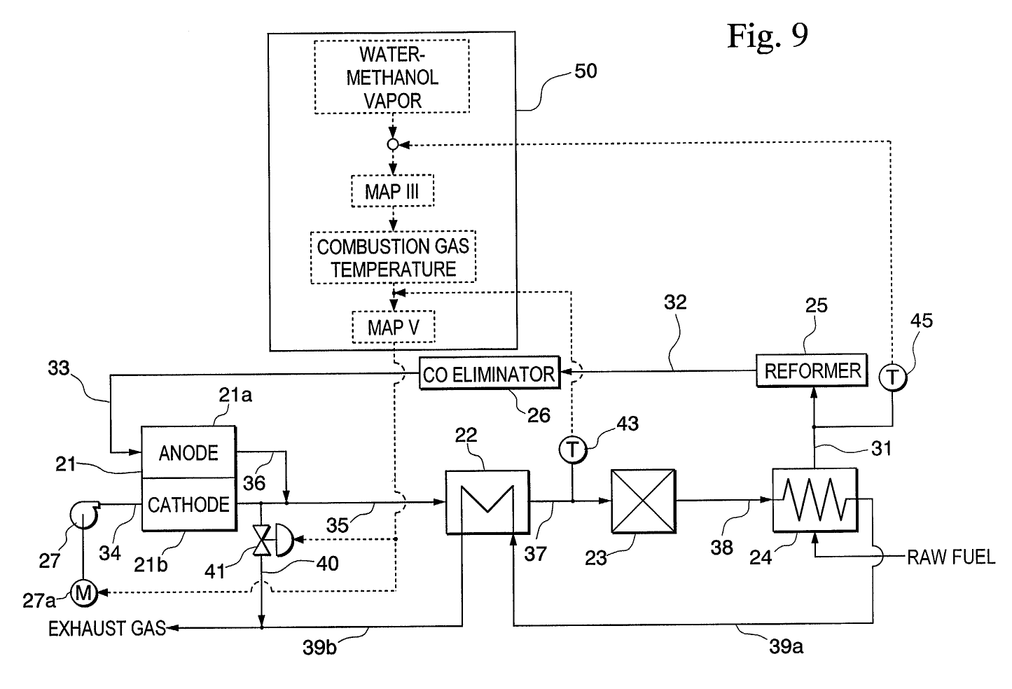

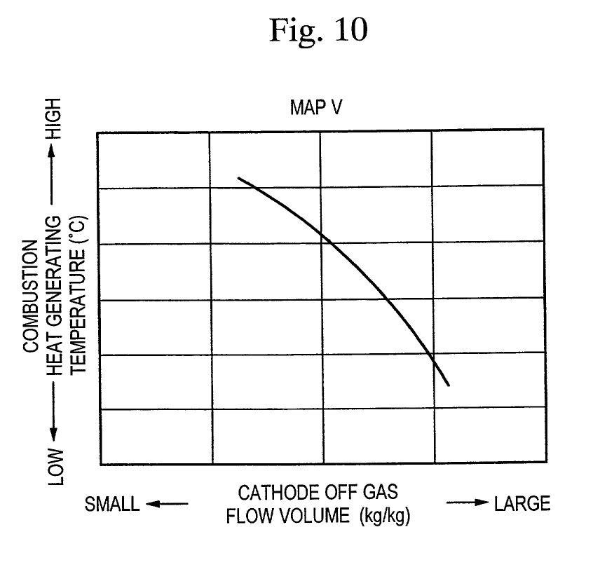

Next, a fourth embodiment of the control method of a heat processing system according to the present invention will be explained while referring to FIG. 9 and FIG. 10. Like the heat processing system according to the second embodiment and the third embodiment, the heat processing system according to the fourth embodiment can be used in a fuel cell system mounted in a fuel cell vehicle.

FIG. 9 is a drawing showing the schematic structure of the fuel cell system according to the fourth embodiment, and in FIG. 9 the control process sequence is also shown in order to make the processing the in the control unit easy to understand.

The control method for a fuel vapor temperature in a fuel cell system according to the fourth embodiment further simplifies the third embodiment described above, and the point of difference between this embodiment and the third embodiment is as follows. First, in the system structure, there is no the oxygen concentration sensor 44, that is, the oxygen concentration sensor for detecting the oxygen concentration in the combustion gas that flows out from the catalytic combustor 23, provided on the off gas pipe 38. The other structures are identical to those of the third embodiment, and thus identical parts are denoted by identical reference numerals and their explanation is omitted.

If the output of the fuel cell stack 21 and the amount of heat supplied to the vaporizer 24 are constant, the amount of anode off gas supplied to the off gas heater 22 and the catalytic combustor 23 is also constant, which device that the amount of fuel supplied to the catalytic combustor 23 is also constant. Therefore, if the amount of the cathode off gas is known, the combustion heat generating temperature in the catalytic combustor 23 can be estimated. Based on this conception, the map V in FIG. 10, which shows the relationship between the combustion heat generating temperature and the cathode off gas flow volume, is found from experimental data by carrying out experiments in the fuel cell system.

Moreover, the cathode off gas flow volume is calculated from the aperture command value of the cathode off gas flow volume control valve 41 and the revolution command value of the drive motor 27a of the supercharger 27.

Next, in the fuel cell system according to this fourth embodiment, the control sequence of the fuel vapor temperature will be explained.

First, the control unit 50 sets the fuel vapor temperature (that is, the required fuel vapor temperature) required by the reformer 25 based on the operational state of the fuel cell vehicle.

Next, based on this required fuel vapor temperature, the combustion gas temperature (that is, the set combustion gas temperature) is set by referring to map III in FIG. 6, which shows the relationship between the fuel vapor temperature (the water-methanol vapor temperature) with respect to the amount of heat supplied to the vaporizer 24 and the combustion gas temperature.

Next, the combustion heat generation temperature is calculated by subtracting the off gas temperature detected by the outlet temperature sensor 43 after heating from the set combustion gas temperature, and the cathode off gas flow volume corresponding to this combustion heat generating temperature is found by referring to the map V in FIG. 10 which shows the relationship between the combustion heat generating temperature and the cathode off gas flow volume.

In addition, the cathode off gas flow volume control is feedback controlled so that the required cathode off gas flow volume is obtained, and the cathode off gas supply amount is controlled. Moreover, instead of controlling the cathode off gas flow volume control valve 41, the amount of air blown can be adjusted by controlling the revolutions of the drive motor 27a of the supercharger 27, and thereby the cathode off gas supply amount can be controlled.

In addition, the difference between the fuel vapor temperature detected by the fuel vapor temperature sensor 45 and the required fuel vapor temperature is fed back, and the set value of the temperature of the combustion gas supplied to the vaporizer 24 is compensated.

In this manner, in the control method for fuel vapor temperature control according to the fuel cell system of the fourth embodiment, an oxygen concentration sensor is not necessary, and thus the system structure can be further simplified, and the costs can be reduced.

As explained above, according to the first and second aspects of the present invention, there is the effect that the temperature of the heating object after heating can be stably controlled with high responsiveness while having a simple structure.

According to the third aspect of the present invention, the combustion gas temperature of the combustor and the amount of heat supplied to the heating device can be adjusted with high responsiveness depending on the process state, and thus there is the effect that the temperature of the heating object after heating is stable.

According to a fourth aspect of the present invention, the fuel vapor supplied to the reformer from the vaporizer can be stably controlled so as to obtain at the fuel vapor temperature required by the reformer, and thus there are the superior effects that the reforming of the vapor fuel in the reformer can be carried out stably, and thus the power generation in the fuel cell can be carried out stably.

What is claimed is:

1. A control method for a heat processing system comprising a combustor that has supplied and then bums a burning gas composed of fuel and air for combustion, a heating device that heats a heating object by introducing a combustion gas produced by said combustor and using the heat of said combustion gas, and a heat exchange device that introduces said combustion gas used by said heating device and transfers the heat to said mixed gas composed of fuel and air from said combustion gas, wherein the control method comprises the steps of:
setting the combustion gas temperature in said combustor based on the required value of the temperature of said heating object obtained by heat processing by said heating device;
setting and adjusting the flow volume of said air depending on said set combustion gas temperature; and
controlling the temperature of said heating object after said heat processing so as to obtain said required value by compensating said set combustion gas temperature based on the comparative value of the required value of the temperature of said heating object and the actual temperature of said heating object after said heating process.

2. A control method for a heat processing system having a combustor that has supplied and then burns a burning gas composed of fuel and air for combustion, a heating device that heats a heating object by introducing a combustion gas produced by said combustor and using the heat of said combustion gas, and a heat exchange device that introduces said combustion gas used by said heating device and transfers the heat to said fuel and said air from said combustion gas, wherein the control method comprises the steps of:
setting an amount of heat supplied to said heating device and a combustion gas temperature of said combustor based on the required value of the amount and the temperature of said heating objects obtained by heat processing by said heating device;
setting and respectively adjusting the flow volume of said fuel and the flow volume of said air depending on said set amount of heat to be supplied to the heating device and said set combustion gas temperature; and
controlling the actual temperature of said heating object after said heating processing and the temperature of said heating object after said heat processing so as to attain said required value by compensating at least one of either said set amount of heat to be supplied or said set combustion gas temperature based on the comparative value of the required value relating to the temperature of said heating object.

3. A control method for a heat processing system according to claim 1 or claim 2 wherein the control method further comprises the steps of:
obtaining an oxygen concentration corresponding to said set combustion gas temperature using a map that shows a relationships between the combustion gas temperature and the oxygen concentration in the combustion gas, and adjusting the amount of said air so that the actual oxygen concentration of the burning gas in said combustor approaches the required oxygen concentration.

4. A control method for a heat processing system according to one of claims 1 and 2, wherein said heating object prior to the heat processing by said heating device is the raw fuel of the fuel cell, said heating device is a vaporizer that generates the fuel vapor by vaporizing said raw fuel, said heating object obtained by heat processing by said heating device is a fuel vapor produced by said vaporizing device, said fuel is the anode off gas discharged after the fuel gas generated by reforming of said fuel vapor by a reformer that has been supplied to the anode electrode of the fuel cell, and said air is the cathode off gas discharged after the air is supplied to the cathode electrode of the fuel cell.
